(19) United States
(12) Patent Application Publication
(10) Pub. No.: US 2011/0044319 A1
(43) Pub. Date: Feb. 24, 2011

(54) EARLY MEDIA AND FORKING IN 3PCC

(75) Inventors: SHAHZAIB YOUNIS, REDMOND, WA (US); DHIGHA D. SEKARAN, REDMOND, WA (US); DANNY LEVIN, REDMOND, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, REDMOND, WA (US)

(21) Appl. No.: 12/544,980

(22) Filed: Aug. 20, 2009

(51) Int. Cl. H04L 12/66

(52) U.S. Cl. 370/352

(57) ABSTRACT

A control server initiates a call to a first device. After creating a connection to the device, the control server reverses the direction of the message flow between the device and the control server such that the device becomes the initiator of the call (the caller) and the control server becomes the device that is called (the callee). A connection is also established between the first device, the control server and a second device that is an endpoint for the call. Early media and forking is available to the first device after reversing the direction of the message flow between the first device and the control server and the callee has been contacted. Additionally, information flows between the first device and the second device through the control server as if the first device and the second device were directly connected.

### BACKGROUND

Different communication applications are designed to make communication easier and more accessible by providing users with a variety of information and functionality. For example, a user may have the ability to contact users through different communications methods, such as telephone calls, text messages, instant messaging (IM) and the like. In addition to a user directly creating a connection with another party, a third party may also be used to connect two or more participants. For example, third party call control (3PCC) system allows a third party to connect two or more parties together in a conversation. The 3PCC established call may be between two IP communication devices, one IP communication device and a telephone, or two telephones. Examples of 3PCC include some operator services as well as click-to-dial services that allow a user to click a link on a web page that in turn connects the user to an individual that is associated with the web site, such as a customer service representative.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A connection is established between two or more endpoints such that early media and forking are available within a call that includes a control server that initiates the call. After a control server creates a connection to the first device, the control server reverses the direction of the message flow between the device and the control server such that the first device is viewed as the initiator of the call (the caller) and the control server becomes the device that is called (the callee). A connection is also established between the first device, the control server and a second device that is another endpoint for the call. Early media and forking is available to the first device after reversing the direction of the message flow between the first device and the control server since the first device is now the caller and not the callee. Additionally, during the connection, the first device and the second device may receive session information through the control server that is acting as a back-to-back agent.

### BRIEF DESCRIPTION OF THE DRAWINGS

FIG. 1 illustrates an exemplary computing environment;

FIG. 2 shows a communications system for reversing a direction of a call initiated by a control server; and

FIG. 3 shows an illustrative process for reversing a direction of a call initiated by a control server.

### DETAILED DESCRIPTION

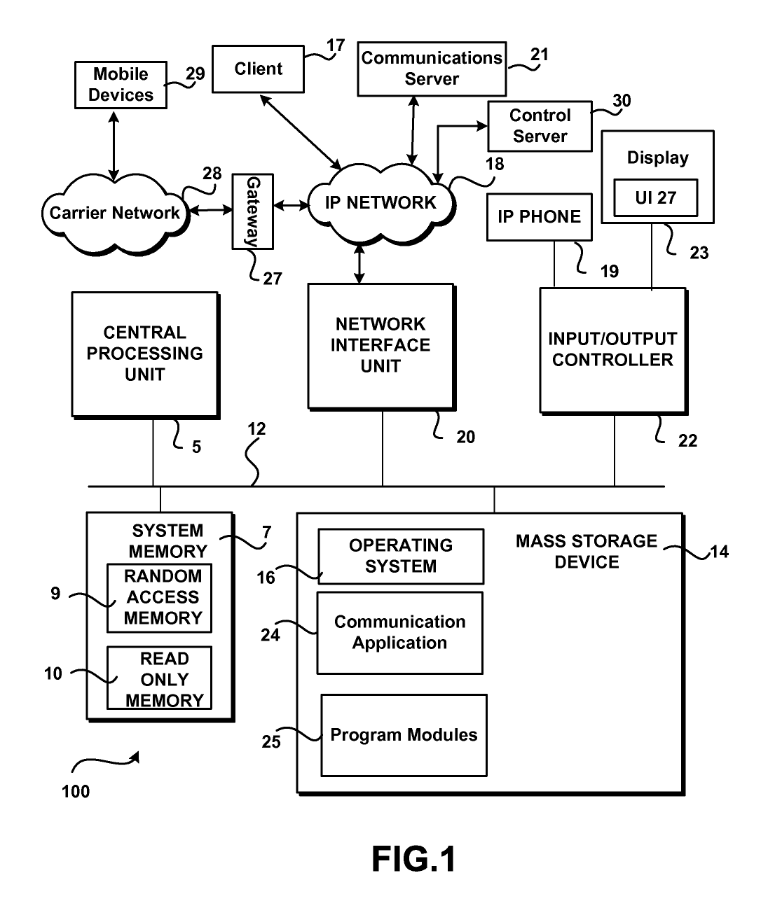

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer shown in FIG. 1 may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, communications application 24 and other program modules 25 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone 19, a display screen 23 showing user interface 27, a printer, or other type of output device.

Carrier network 28 is a network responsible for communicating with mobile devices 29. The carrier network 28 may include both wireless and wired components. For example, carrier network 28 may include a cellular tower that is linked to a wired telephone network. Typically, the cellular tower carries communication to and from mobile devices, such as cell phones, notebooks, pocket PCs, long-distance communication links, and the like.

Gateway 27 routes messages between carrier network 28 and IP Network 18. For example, communications server 21 may route a call or some other message to a mobile device on carrier network 28 and/or route a call or some other message to a user's device on IP network 18. Gateway 27 provides a means for transporting the communication from the IP network to the carrier network. Conversely, a user with a device connected to a carrier network may be directing a call to a client on IP network 18.

Control server 30, such as a Third Party Call Control (3PCC) server, is configured to initiate a connection between two or more devices, such as between two phones, a phone and an IP device, or two IP devices. For example, control server 30 may initiate a connection between IP phone 19 and client 17, mobile device 29 and IP phone 19, or two other devices. Generally, 3PCC allows a controller, such as control server 30, to set up and manage a communications relationship between two or more other parties. 3PCC is commonly used for operator services, conferencing, and click-to-dial services. For example, in a click-to-dial scenario, a user may click on a link on a web page that causes control server 30 to connect the user with a user that is associated with the web site.

As mentioned briefly above, a number of program modules and data files may be stored in the mass storage device 14 and RAM 9 of the computer 100, including an operating system 16 suitable for controlling the operation of a computer, such as WINDOWS COMMUNICATION SERVER®, WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs 24 and program modules 25.

Communication application 24 is configured to process information relating to a communication session that is established between computing device 100 and one or more other devices. According to one embodiment, communication application 24 is an application such as MICROSOFT's OFFICE COMMUNICATOR®. Communications application 24 may be utilized during the phases of communication sessions between computing device 100 (i.e. IP phone 19) and one or more other devices. These communication sessions may be established directly between devices and/or indirectly through a control server, such as control server 30. Even when a call is established between two or more endpoints using the control server as an intermediary, the flow of information between the endpoints may be configured such that one endpoint is considered the caller and the another endpoint is considered the callee for the call. For example, assume that control server 30 initiates a call to computing device 100. After control server 30 creates a connection to computing device 100 using communication application 24, control server 30 reverses the direction of the message flow between computing device 100 and control server 30 such that the computing device 100 is viewed as the initiator of the call (the caller) and control server 30 becomes the device that is called (the callee). A connection is also established between the computing device 100, control server 30 and a second device (e.g. client 17 and/or mobile device 29) that is an endpoint for the call. Early media and forking are now available to computing device 100 after reversing the direction of the message flow between computing device 100 and control server 30. Generally, Early media refers to media (e.g., audio and video) that is exchanged before a particular session is accepted by the callee. Early media can occur from the moment the initial INVITE is sent until the session is accepted by the callee. The early media may flow in any direction between the caller and the callee. Early media is typically used to send ringing tones and announcements, using either audio streams or Dual Tone Multi-Frequency (DTMF) events. Forking refers to forwarding a SIP request to multiple SIP addresses and returning the responses to the caller. Prior solutions, on the other hand, required that the first INVITE is initiated from the caller and not by a control server. Additionally, during the connection, computing device 100 may push session information through control server 30 to one or more of the endpoint(s) (i.e. client 17). More detail is provided in the description below regarding the changing of message flow during a call.

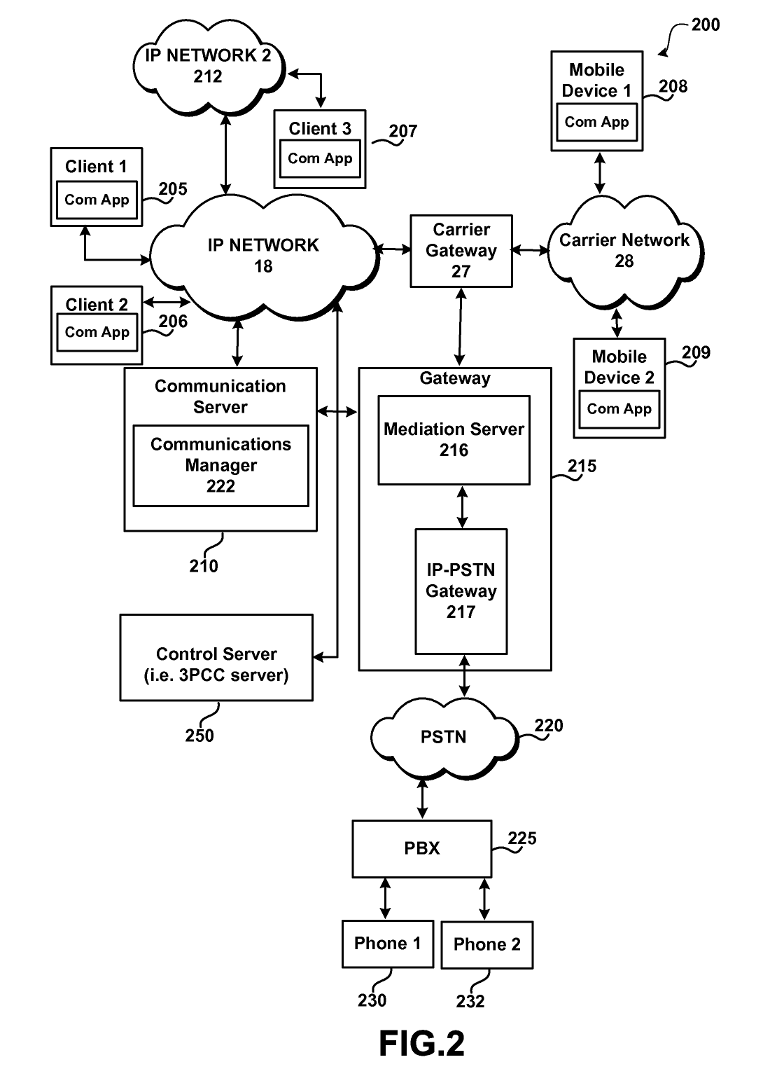

FIG. 2 shows a communications system for reversing a direction of a call initiated by a control server. As illustrated, system 200 includes client 1 (205) and client 2 (206) that is coupled to IP Network 18, client 3 (207) that is coupled to IP Network 2 (212), mobile device 1 (208) and mobile device 2 (209) that are coupled to carrier network 28, communication server 210 including communications manager 222, control server 250, carrier gateway 27, gateway 215, mediation server 216, IP-PSTN gateway 217 coupled to PBX 225 through PSTN 220 and phone 1 (230) and phone 2 (232).

The communication server 210 is configured to route incoming communications to the appropriate destinations. According to one embodiment, communications server 210 runs Microsoft's OFFICE COMMUNICATION SERVER® operating system. At least some of the devices (205-209) are configured with a communication application, such as Microsoft's OFFICE COMMUNICATOR® application. Other communication applications may also be utilized.

According to one embodiment, communications server 210 utilizes SIP for communication sessions. For more information on this industry standard protocol see IETF RFC 3261 which may be found at http://www.ietf.org/rfc/rfc3261.txt. Generally, SIP defines a standard for session setup, termination, and media negotiation between two parties that is widely used for Voice-over-IP (VoIP) call signaling.

Generally, communication server 210 routes communications/calls to endpoints on the IP network (IP-IP calls); routes calls to the public switched telephone network (PSTN)/PBX (IP-PSTN calls) and may also route calls to destinations using other networks, such as a carrier network. The communication server 210 may be coupled to the networks through one or more gateways. A gateway translates signaling and media between the network and the IP voice infrastructure. The gateway 215 may be composed of one or more devices. For example, the gateway 215 may be implemented as a mediation server 216 and an IP-PSTN gateway 217 or the functionality of the mediation server and the IP-PSTN may be included within the gateway as illustrated. Generally, IP-PSTN gateway 217 is a gateway that is located between a landline phone (i.e. phone 1 or phone 2) and any SIP User Agent Client (i.e. client 1, client 2, client 3). Gateway 217 allows a person to call any (allowed) telephone number from any SIP-compliant client application.

Mediation Server 216 provides signaling and media translation between the VoIP infrastructure and a gateway. Mediation Server 216 also links the Communication Server 210 with a PBX 225. On the communications server side, the media server 216 listens on a mutual TLS transport address. TLS (Transport Layer Security), is a protocol for establishing a secure connection between a client and a server. TLS (Transport Layer Security) is capable of authenticating both the client and the server and creating a encrypted connection between the two. The TLS (Transport Layer Security) protocol is extensible, meaning that new algorithms can be added for any of these purposes, as long as both the server and the client are aware of the new algorithms. On the gateway side, mediation server listens on a single TCP/IP transport address. Generally, the mediation server 216 is configured for: translating SIP over TCP (on the gateway side) to SIP over mutual TLS (on the Enterprise Voice side); encrypting and decrypting SRTP (Secure Real-time Transport Protocol) on the communications server side; translating media streams between the communications server and the gateway; connecting clients that are outside the network to internal ICE (Interactive Connectivity Establishment) components, which enable media traversal of NAT and firewalls; and acting as an intermediary for call flows that a gateway does not support, such as calls from remote workers on an enterprise voice client.

Communications server 210 may be configured to provide communication services for one or more locations. For example, communications server 210 may be utilized for a business having branch offices that are connected using IP Network 18 and/or other IP networks (e.g. IP Network 2 (212)). For example, Client 3 may be located at a branch office while communication server 210 is located at the main office.

Control server 250 may be configured as a 3PCC server and is utilized to initiate and manage a connection between two or more devices, such as between two phones, a phone and an IP device, or two IP devices. Control server 250 may also be configured as a back-to-back user agent (B2BUA). A back-to-back user agent (B2BUA) is an entity that receives a request and processes it as a user agent server (UAS). In order to determine how the request should be answered, it acts as a user agent client (UAC) and generates requests. Unlike a proxy server, it maintains dialog state and participates in the requests sent on the dialogs it has established. Control server 250 may initiate a call based on a request made from different sources. For example, control server 250 may initiate a call based on a request from communication server 210, a direct request from a user (i.e. through an operator), through a click-to-dial service, and the like.

Generally, two separate channels are used to establish a voice session between two or more endpoints. One channel is a bearer channel (VoIP) and another channel is a signaling channel (SIP) that defines the session characteristics and also controls the bearer channel. These channels established directly between the endpoints, where one endpoint initiates a request to establish a voice session with another endpoint and media flows directly between the endpoints via a Real Time Transport Protocol (RTP).

In some cases, an endpoint can't start a Voice over Internet Protocol (VoIP) session because of the limitation of bandwidth, such as, mobile-devices with limited data-network bandwidth access (e.g. mobile device 208). For example, mobile device 208 may have sufficient bandwidth to register as an endpoint for IM and presence purposes but not for VoIP session. In this case, control server 250 may act as a bridge to assist mobile device 208 in establishing a voice session with one or more other devices. In this example, mobile device 208 using its communication application may request control server 250 to connect itself with another endpoint (e.g. client 205) or control server 250 may receive a request from communication server 210 to connect mobile device 208 with client 205.

The following example is provided for purposes of explanation and is not intended to be limiting. The method described using SELF-REFER with SDP-less INVITE to enable SIP 3PCC can be applied in many different ways and is therefore not to be limited to the examples that are described herein. Assume in the current example, that mobile device 208 does not have sufficient bandwidth to establish a VoIP session, but has enough bandwidth to establish a SIP channel.

Initially, mobile device 208 sends a request to communications server 210 to connect to client device 205. In this case, a communication channel can not be established directly between the two devices. As such, communication server 210 requests control server 250 to assist in connecting mobile device 208 with client device 205. Control server 250 sends an SIP SDP-LESS INVITE request to carrier gateway 27 to initiate a call with mobile device 208. After mobile device 208 is connected, control server 250 self-refers the call initiated with mobile device 208 by sending a SIP SELF-REFER request to the gateway. This self-referring request is a request to the gateway to transfer the call that was just established between the gateway and mobile device 208 back to control server 250 that requested the call be made.

In this case, the call is being switched from being controlled by the control server 250 to being initiated by mobile device 208. After accepting the self-referral transfer request, the gateway initiates the transfer by sending an SIP INVITE request to control server 250. When the INVITE request is received by control server 250 it accesses the SIP-SDP Offer (media-session information) received from the gateway and uses that information to connect to client device 205. At this point, control server 250 acts as a back-to-back agent that connects the call between mobile device 208 and client device 205.

For the remainder of the call-flow between mobile device 208 and client device 205, the information sent by mobile device 208 can be pushed to client device 205 and information sent by client device 205 can be pushed to mobile device 208. Connecting the device in the manner described does not require special-logic in order to communicate SIP-forking or early-ICE information to a remote party. Instead, the information flows the same way from callee to caller as it would flow if they were connected directly. Even though a control server is involved in establishing the connection between the devices, the caller and callee are connected such that callee-forking information can flow back to caller in the same way the caller would be talking to the callee if connected directly. This connection method also allows the flow of early-ICE information between caller and callee, which assists in the media-connection establishment between the parties involved in the communication session. Instead of the control server having to ask for the information from one endpoint (callee/caller) first and then communicating to other endpoint either via UPDATE/re-INVITE, one endpoint is now engaged in such a way that the endpoint can push the session-information to control server 250 via SIP provisional/final responses or requests which control server 250 then back-to-backs to the other endpoint via same responses/requests. The control server is configured both for back-to-backs of final responses but also provisional responses with forking and early ICE information. This assists a caller to know the number of endpoints the call was forked to, to expedite the media-session establishment between the media-terminating endpoints, and to enable early-media flow. The control server does not terminate the media. Instead, it terminates the signaling aspects of the session and the media flows directly between the two endpoints (the callee and the caller).

As discussed above, other examples may utilize this call flow redirection. For example, the control server 250 may initiate a call based on a request made directly from a user (i.e. through an operator and/or a click-to-dial request). In this example, assume that control server 250 has been requested to connect client 205 with client 206. The process as described above is applied in the same manner absent having to use a gateway to connect voice communication to the device. After the control server 250 connects one of the clients it can send a self-refer request directly to the client to transfer the call back to the control server. After the self-referral, control server 250 acts as a back-to-back agent between client 205 and client 206.

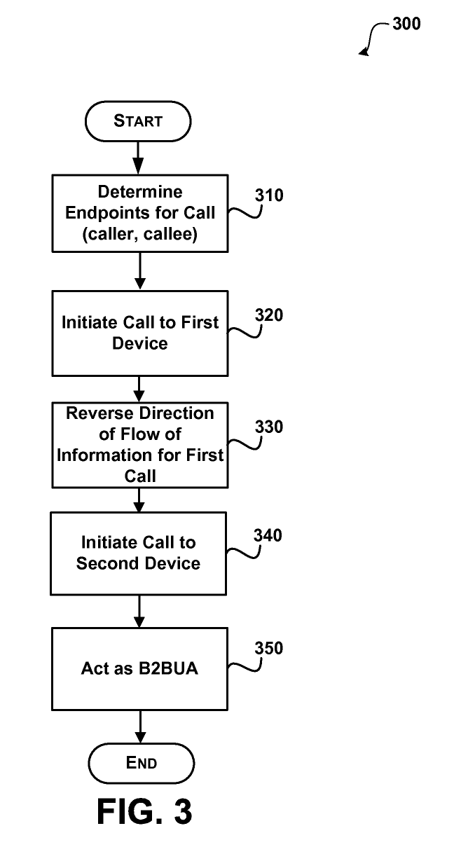

Referring now to FIG. 3, an illustrative process 300 for reversing a direction of a call initiated by a control server will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310, where the endpoints for the call are determined. For example, the endpoints may be different IP devices, a phone and an IP device, two phones, and the like. A determination is also made as to what endpoint is to be considered the caller and which endpoint(s) is considered the callee.

Moving to operation 320, the control server initiates a call to the first endpoint. According to one embodiment, the first endpoint will be considered the caller after the control server self-refers the call to itself.

Flowing to operation 330, the flow of information between the control server and the first endpoint is reversed. The control server self-refers the call initiated with the first endpoint by sending a SIP SELF-REFER request. This self-referring request is a request to transfer the call that was just established back to the control server.

Transitioning to operation 340, the control server initiates a call to the second endpoint. After the control server receives an INVITE request that is generated in response to the SIP SELF-REFER request, the control server accesses the SIP-SDP Offer (media-session information) received and uses that information to connect to the second endpoint.

At operation 350, the control server acts as a back-to-back agent for the remainder of the connection. During this time, the information received from the first endpoint can be pushed to the second endpoint and the first endpoint can receive information regarding the forking and early media from the second endpoint.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method executing on a processor of a computing device for reversing a direction of a flow for a call, comprising:
establishing a first call to a first device from a control server; wherein the first device is a callee and the control server is the caller;
reversing a direction of a flow for the first call such that the first device becomes the caller and the control server becomes the callee; and
establishing a call between the first device and a second device such that the first device pushes session information to the second device.

2. The method of claim 1, wherein reversing the direction of the flow of the first call comprises the control server sending a self-refer request that requests a transfer of the call back to the control server.

3. The method of claim 2, further comprising in response to the self-refer request sending an invitation to the control server and the control server accessing media-session information associated with the invitation and sending an invitation to the second device with the media-session information.

4. The method of claim 3, wherein establishing the first call to the first device from the control server comprises sending a SIP SDP-LESS INVITE request that is used in establishing the first call with the first device.

5. The method of claim 4, wherein the SIP SDP-LESS INVITE request is received by a gateway that is configured to call the first device.

6. The method of claim 4, wherein the self-refer request is received by the gateway that is configured to send an SIP INVITE request to the control server.

7. The method of claim 1, wherein the first call and the second call are established through SIP messages.

8. The method of claim 7, wherein the control server acts as a back to back agent between the first device and the second device after the second device is connected to the control server.

9. The method of claim 8, wherein the control server processes final responses and provisional responses for establishing forking and early ICE information.

10. The method of claim 7, wherein the control server is a third party call control server that initiates a call to the first device in response to a selection on a website.

11. A computer-readable storage medium having computer-executable instructions for reversing a direction of a flow for a call involving a computing device coupled to a communications server through a communication application, comprising:
establishing a first call to a first device from a control server; wherein the first device is a callee and the control server is the caller;
reversing a direction of a flow for the first call such that the first device becomes the caller and the control server becomes the callee; wherein reversing the direction of the flow of the first call comprises the control server sending a self-refer request that requests a transfer of the call back to the control server; and
establishing a call between the first device and a second device such that the first device pushes session information to the second device through the control server; wherein the control server processes final responses and provisional responses for establishing forking and early ICE information after establishing a connection between the first device and the second device.

12. The computer-readable storage medium of claim 11, further comprising in response to the self-refer request sending an invitation to the control server and the control server accessing media-session information associated with the invitation and sending an invitation to the second device with the media-session information.

13. The computer-readable storage medium of claim 12, wherein establishing the first call to the first device from the control server comprises sending a SIP SDP-LESS INVITE request that is used in establishing the first call with the first device.

14. The computer-readable storage medium of claim 14, wherein the SIP SDP-LESS INVITE request is received by a gateway that is configured to call the first device.

15. The computer-readable storage medium of claim 14, wherein the self-refer request is received by the gateway that is configured to send an SIP INVITE request to the control server.

16. The computer-readable storage medium of claim 13, wherein the control server acts as a back to back agent between the first device and the second device after the second device is connected to the control server.

17. A system for reversing a direction of a flow for a call, comprising:
a network connection that is configured to connect to the IP network;
a processor and a computer-readable medium;
an operating environment stored on the computer-readable medium and executing on the processor; and
a process operating under the control of the operating environment and operative to:
establishing a first call to a first device using a control server;
wherein the first device is a callee and the control server is the caller;
reversing a direction of a flow for the first call such that the first device becomes the caller and the control server becomes the callee;
wherein reversing the direction of the flow of the first call comprises the control server sending a self-refer request that requests a transfer of the call back to the control server; and
establishing a call between the first device and a second device such that the first device pushes session information to the second device through the control server; wherein the control server processes final responses and provisional responses for establishing forking and early ICE information after establishing a connection between the first device and the second device.

18. The system of claim 17, further comprising in response to the self-refer request sending an invitation to the control server and the control server accessing media-session information associated with the invitation and sending an invitation to the second device with the media-session information.

19. The system of claim 18, wherein establishing the first call to the first device from the control server comprises sending a SIP SDP-LESS INVITE request that is used in establishing the first call with the first device.

20. The system of claim 19, wherein the first call is established in response to an operator request that is associated with a third party call control.
